(19) United States
(12) Patent Application Publication
(10) Pub. No.: US 2025/0238344 A1
(43) Pub. Date: Jul. 24, 2025

(54) RESOLUTION OF CODEBASE COMPLICATIONS VIA FOUNDATION MODEL INTEGRATION

(71) Applicant: AppLand Inc., Weston, MA (US)

(72) Inventors: Elizabeth Lawler, Weston, MA (US); Kevin Gilpin, Weston, MA (US)

(21) Appl. No.: 18/421,243

(22) Filed: Jan. 24, 2024

(51) Int. Cl. G06F 11/36

(52) U.S. Cl. CPC G06F 11/3608; G06F 11/3612; G06F 11/3698

(57) ABSTRACT

Technology is disclosed herein by which a system of one or more computing devices identifies a run-time complication in a codebase and generates a solution for the run-time complication via a foundation model integration. In an implementation, the system accesses a behavioral model of a codebase. The behavioral model represents a run-time behavior of the codebase based on a run-time analysis of the codebase. The system interrogates the behavioral model to predict run-time complications within the codebase. The system receives, in a user interface, a selection of a run-time complication and generates a prompt tasking a foundation model with generating a solution for the selected run-time complication. The prompt includes a portion of the codebase which corresponds to the selected complication. The system causes display of the solution generated by the foundation in response to the prompt in the user interface.

### INCORPORATIONS

This application incorporates the contents of U.S. patent application Ser. No. 18/356,428, titled “INTELLIGENT RUN-TIME COMPLICATION IDENTIFICATION AND SOLUTIONS FOR A CODEBASE,” Attorney Docket No. 717.0005, filed Jul. 21, 2023, the contents of which are incorporated herein by reference in its entirety for all purposes.

### TECHNICAL FIELD

Aspects of the disclosure are related to the field of computer software applications and, in particular, to identifying run-time complications within a codebase and providing recommended solutions via foundation model integration.

### BACKGROUND

Generating and maintaining robust and reliable software requires testing the codebase to identify and address issues impacting the quality, performance, and security of the software. Typical methods to identify complications within a codebase of a software application rely on static and dynamic analyses of the codebase. Static analysis methods examine the codebase without executing the software application, while dynamic analyses examine a codebase while the application is running to identify run-time-specific complications. By analyzing the codebase directly, these methods can separately identify software issues, such as performance-related issues (e.g., inefficient data processing), security risks, erroneous output, issues of incompatibility between legacy code and updated code, and so on.

Once an issue is identified in a codebase, a solution must be found. In any scenario, devising a solution to the problem involves understanding the full impact that the solution will have throughout the codebase. In a complex codebase, this can mean exhaustively tracing interactions of the impacted code block with multiple interconnected components according to processes or threads of execution and understanding the potential effects of the solution on those components. Because a developer seeking to fix the issue may not be familiar with all of the potentially affected areas of the codebase, this means that potentially multiple developers will be involved in resolving a single issue which in turn may require coordinating their efforts to ensure the solution is effective without creating unintended side effects elsewhere in the codebase.

### Overview

Technology is disclosed herein by which a system of one or more computing devices identifies a run-time complication in a codebase and generates a solution for the run-time complication via a foundation model integration. In an implementation, the system accesses a behavioral model of a codebase. The behavioral model represents a run-time behavior of the codebase based on a run-time analysis of the codebase. The system interrogates the behavioral model to predict run-time complications within the codebase. The system receives, in a user interface, a selection of a run-time complication and generates a prompt tasking a foundation model with generating a solution for the selected run-time complication. The prompt includes a portion of the codebase which corresponds to the selected complication. The system causes display of the solution generated by the foundation in response to the prompt in the user interface.

Implementations may include one or more of the following features. In an implementation, to generate the prompt, the system identifies the portion of the codebase corresponding to the selected run-time complication based on the behavioral model. In some implementations, the prompt includes information from the behavioral model about the selected run-time complication, including a type of run-time complication. The prompt may also task the foundation model with generating an explanation of the selected run-time complication and the solution, and the system may display the explanation in association with the complication in the user interface.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for AI-generated solutions to run-time complications in an implementation.

FIG. 2 illustrates an exemplary computing system for AI-generated solutions to run-time complications in an implementation.

FIG. 3 depicts a codebase behavioral model, according to some embodiments.

FIG. 4 illustrates a user interface for a system for AI-generated solutions to run-time complications, according to some embodiments.

FIG. 5 illustrates a user interface for a system for AI-generated solutions to run-time complications, according to some embodiments.

FIG. 6 illustrates user interfaces for a system for AI-generated analysis of a codebase based on a behavioral model, according to some embodiments.

FIG. 7 illustrates a method for AI-generated solutions to run-time complications in an implementation.

FIG. 8 illustrates a computing system suitable for implementing the various operational environments, architectures, processes, scenarios, and sequences discussed below with respect to the other Figures.

### DETAILED DESCRIPTION

Various implementations are disclosed herein that describe technology for identifying run-time complications within a codebase and generating a recommended solution to mitigate or resolve an identified complication via an integration to a foundation model. Run-time complications within a codebase can include bugs, performance issues, security risks, design flaws, and other types of complications which may result in memory leaks, inefficient data access, invalid links, improper access control, etc. In particular, some run-time complications may be difficult to identify or diagnose prior to deployment outside of a development environment. For example, a debugger may not be able to identify performance issues until sufficient performance data is collected. In other cases, a memory leak or inefficient data access may not become apparent until an application faces production-level demands on the codebase.

In an implementation, a system for run-time complication identification identifies run-time complications within a codebase by accessing and interrogating a behavioral model of the codebase. The behavioral model depicts the run-time behavior of the codebase based on a run-time analysis of the codebase. With a run-time complication identified, the system generates a prompt for a foundation model which tasks the model with generating a recommended solution for resolving the run-time complication. The foundation model may be a deep learning artificial intelligence (AI) model based on a trained neural network architecture capable of natural language processing and code generation, such as code in Python, Ruby, or other programming languages. In generating the prompt for the foundation model, the system automatically populates the prompt with a portion of the codebase to which the run-time complication pertains based on information from the behavioral model. The prompt may also include information about the run-time complication from the behavioral model.

Upon submitting the prompt to the foundation model, a user interface hosted by the system receives and displays the recommended solution including a snippet of code for installation in the codebase. In the user interface, the user may accept, modify, or reject the solution. When the user accepts the solution, the system patches the codebase with the generated code snippet (or the generated code snippet as modified by the user). The system may also display a discussion or explanation of the complication and solution which was generated by the foundation model in response to the prompt. In some implementations, the system validates the AI-generated code snippet prior to patching the code snippet into the codebase to ensure the code snippet works as intended.

In various implementations, the behavioral model depicts the run-time behavior of the codebase based on a run-time analysis of the codebase. The system interrogates the behavioral model to identify run-time complications within the codebase. For example, run-time complications may be identified based on known problem patterns associated with the complications. For a given run-time complication, the recommended solution generated by the foundation model may include a code snippet to replace a corresponding portion of code in the codebase. The recommended solution may be surfaced via a pop-up window in the user interface, or in other scenarios, the recommended solution may be provided to the user as a redirection to a different page in the user interface, a redirection to an external website, or the like. The user interface displaying the AI-generated solution may also provide a visual depiction of the relevant portion of the behavioral model, listings of other run-time complications, and access to other recommended solutions.

In some implementations, the system for run-time complication identification may be software that can be downloaded and executed on a server. In some implementations, the system may be a cloud-based service hosted by a service provider. In a cloud-based service implementation, online services to intelligently identify the run-time complications within the codebase are provided and a user interface is hosted that provides visualizations for the user to access.

In some implementations, the system submits prompts to the foundation model for user inquiries about the codebase. The system may display a listing or menu of sections of the codebase or a visual depiction of the codebase generated based on the behavioral model in the user interface, and the user may select a portion of the codebase in the user interface for further examination or inquiry. The system generates a prompt which tasks the foundation model with generating a response to the user's natural language inquiry. The user inquiry along with the relevant portions of the codebase (e.g., the selected portion of the codebase and other portions of the codebase which relate to the selected portion according to the behavioral model) are used to populate the prompt to the foundation model.

For example, the user may select a function definition from the codebase and inquire as to the particular outcome which would occur in a what-if scenario. The system populates the prompt with the user inquiry and the selected function definition along with other portions of the codebase which are identified as relevant to the selected portion according to the behavioral model of the codebase. The foundation model may be tasked with generating its answer along with a brief explanation for the answer. Upon receiving the reply to the prompt from the foundation model, the system displays the answer and any other requested information in the user interface.

When the user wishes to submit a natural language inquiry to obtain more information about a particular section of code, the user may select a portion of interest and submit the inquiry in association with the selection. The user may select the portion of interest from a listing of lines of code displayed in the user interface or from a visual representation of the codebase based on the behavioral model of the codebase, such as a visual depiction of the behavioral model or a sequence diagram of the codebase based on the behavioral model. When the user selects lines of code or a portion of the codebase in the visual depiction or sequence diagram, the system automatically populates the prompt with the relevant portions or code blocks based on the user's selection. In some cases, the user need only select a single line in a code block of interest, and the system populates the prompt with the entire code block. Similarly, the user may select a single element (e.g., an arrow) of a sequence diagram, and the system populates the prompt with the relevant code blocks which are associated with the element.

In other scenarios, the system performs a run-time analysis of the codebase using test cases or test scripts to probe the codebase as it executes. For example, the system may generate and execute test cases that probe the codebase, and the execution of the codebase using those test cases may be recorded to generate trace files. Trace files may be recorded for various processes or threads of codebase execution. For example, the trace files may be generated based on recording user interaction with the executing codebase (e.g., a user interacting with a user interface hosted by the codebase). The trace files may be generated for other processes or threads of execution such as background jobs, message queue activity, server requests (e.g., HTTP server requests, database server requests, etc.), and the like. Isolated code blocks of the codebase (e.g., a Ruby block, a Java runnable) or lines of code from the codebase may also be executed according to a test script to generate the trace files. Processes may include, for example, a login/authentication process, a data submission process (e.g., submission of data entered by a user into a user interface), or any other process. Trace files may also be generated based on running a testing scenario which generates synthetic traffic to simulate a large number of users accessing the executing codebase in a production environment.

In a codebase testing scenario, a test case or test script itself may contain a bug or complication which causes anomalous test results to be produced. The system may prompt the foundation model to analyze the defective test case or script to identify the bug, then suggest a solution to rectify the identified issue. For example, the prompt may task the foundation model with identifying the bug based on comparing non-anomalous or expected codebase test behavior with the anomalous test results. The analysis of the defective test case or script and solution may be presented to the user in the user interface where the user can accept the solution.

Foundation models of the technology disclosed herein include large-scale generative artificial intelligence (AI) models trained on massive quantities of diverse, unlabeled data using self-supervised, semi-supervised, or unsupervised learning techniques. Foundation models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. In some scenarios, a foundation model may be fine-tuned for specific downstream tasks. Foundation models include BERT (Bidirectional Encoder Representations from Transformers) and ResNet (Residual Neural Network). Types of foundation models may be broadly classified as or include pre-trained models, base models, and knowledge models, depending on the particular characteristics or usage of the model. Foundation models may be multimodal or unimodal depending on the modality of the inputs.

Multimodal models are a class of foundation model which extend their pre-trained knowledge and representation capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video-generating a text description of the video or generating video based on a text description.

Multimodal models include visual-language foundation models, such as CLIP (Contrastive Language-Image Pre-training), ALIGN (A Large-scale ImaGe and Noisy-text embedding), and VILBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of foundation model which processes and generates natural language text. These models are trained on massive amounts of text data and learn to generate coherent and contextually relevant responses given a prompt or input text. LLMs are capable of understanding and generating sophisticated language based on their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. Indeed, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses which are creative, open-ended, and unpredictable.

Implementations of the technology described herein provide various advantages over available technologies. Run-time complications that would not be identified prior to production-level deployment can be identified, saving human capital time and resources, processor and memory resources, and application downtime. For example, the run-time complications can be pinpointed without waiting for production downtime to perform a post-issue root-cause analysis. Rather, the root-cause of issues are identified prior to a run-time complication arising in a production environment, and a recommended solution can be quickly implemented by generating the solution by the foundation model and automating the installation of the recommended code snippet into the codebase based on the behavioral model.

In particular, the interface of the run-time complication identification system allows the user to select a particular run-time complication for resolution without having to dig into the codebase to find the relevant lines of code. Rather, the system uses the behavioral model to automatically populate a prompt template for the foundation model, then parse and display the output from the foundation model in highly consumable format for the user. In a similar manner, the user may select a portion (e.g., a code block) of the codebase and submit a natural language inquiry. The system uses the behavioral model to auto-populate a prompt template for codebase inquiries including the selected code block, then parses and displays the output in the user interface.

Further, the natural language interface of the foundation models promotes user engagement in resolving code issues. For example, when a run-time complication is identified in the codebase, the user can not only cause the foundation model to be prompted for a resolution but also receive more detailed analysis of the problem and solution in natural language, absent arcane or idiosyncratic programming notation, abbreviations, and so on. This enables the programmer to implement a recommended solution more quickly without having to bolster his or her familiarity with the source code. Further, the user can use the foundation model interface to chase down information in the codebase much more quickly than manually tracing variables through the code.

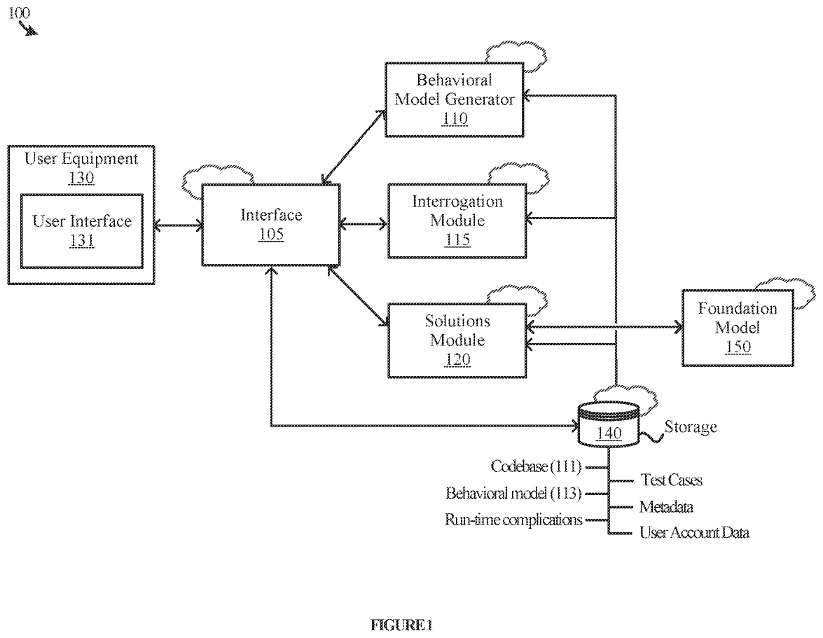

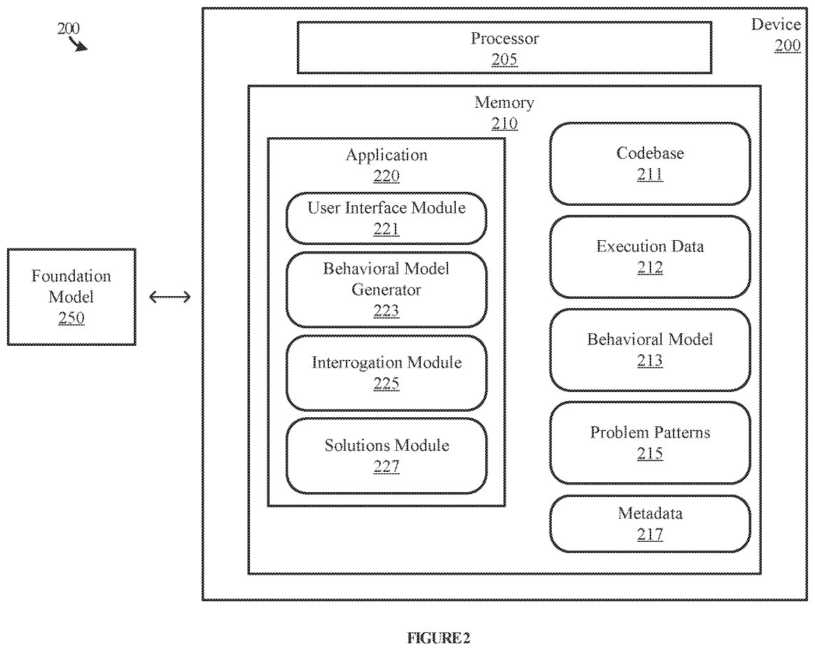

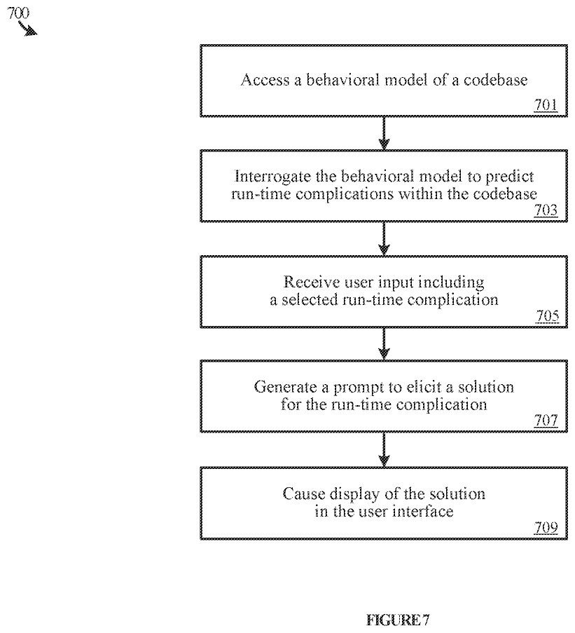

Turning to the figures, FIG. 1 illustrates operating environment 100 for run-time complication identification and resolution via a foundation model integration in an implementation. Operational environment 100 illustrates a cloud-based system to perform the run-time complication identification for a codebase served by a cloud-based service in an implementation. Operating environment 100 includes interface 105, behavioral model generator 110, interrogation module 115, solutions module 120, storage 140, and user equipment 130. Operational environment 100 represents an exemplary environment in which process 700 of FIG. 7 may be executed. A local implementation of a system for run-time complication identification and resolution is illustrated in FIG. 2, but the specific implementation of the functionality described herein does not depart from the scope of the description, whether performed via a local implementation, a cloud-based implementation, or a distributed (i.e., client-server) implementation, using a single computing system or multiple computing systems.

Interface 105 represents a cloud-based interface to make online services accessible for identifying and resolving run-time complications within a codebase. In an implementation, interface 105 makes the online services described herein accessible via user interface 131 on user equipment 130. Interface 105 may communicate with behavioral model generator 110, interrogation module 115, solutions module 120, as well as storage 140 to facilitate generating run-time complications and recommended solutions for the user's codebase and to provide results to the user via user interface 131. Interface 105 may be software that executes on a cloud-based server. Interface 105 may execute on the same server or a different server than the server(s) executing the behavioral model generator 110, interrogation module 115, solutions module 120, and/or storage 140. Interface 105 may execute on a server or computing system accessible by behavioral model generator 110, interrogation module 115, solutions module 120, storage 140, or a combination thereof.

Behavioral model generator 110 generates a visual representation of the user's codebase in operation. Behavioral model generator 110 monitors one or more run-time operations of user equipment 130 which executes the user's uploaded or stored codebase to generate a behavioral model of the codebase in operation. Behavioral model generator 110 may include instructions executed by a processor on a computing system such as a server. In an implementation, behavioral model generator 110 may interact with storage 140 to source inputs for a behavioral model generation, such as codebase 111. Behavioral models generated by behavioral model generator 110 can be stored in storage 140, such as behavioral model 113. Behavioral model generator 110 may execute on the same server or a different server than the server(s) executing interrogation module 115, solutions module 120, and interface 105. Behavioral model generator 110 may execute on a server or computing system accessible by interface 105, interrogation module 115, solutions module 120, storage 140, or a combination thereof.

Interrogation module 115 interrogates a behavioral model, such as behavior model 113 generated by behavioral model generator 110, to identify run-time complications within the user codebase. Interrogation module 115 may include instructions executed by a processor on a computing system such as a server. Interrogation module 115 may interact with storage 140 to obtain run-time complications, behavioral models, test cases, and so on. Interrogation module 115 may identify run-time complications within a user codebase based on the behavioral model of the codebase, such as identifying run-time complications based on known problem patterns identified in the behavioral model. When a run-time complication is identified within the user codebase, interrogation module 115 may communicate this identified run-time complication to interface 105 and store the data or metadata associated with the identified complication in storage 140. In some implementations, interrogation module 115 may utilize an AI engine to intelligently identify run-time complications within the codebase. Interrogation module 115 may execute on a server or computing system accessible by interface 105, behavioral model generator 110, solutions module 120, storage 140, or a combination thereof. Interrogation module 115 may execute on the same server or a different server than the server(s) executing behavioral model generator 110, solutions module 120, and interface 105.

After a run-time complication has been identified by interrogation module 115, in an implementation, interface 105 communicates the identified run-time complication to solutions module 120. Solutions module 120 provides one or more recommended solutions to the corresponding run-time complication. To provide a recommended solution to a run-time complication, solutions module 120 configures a prompt for foundation model 150 including a portion of the codebase to which the complication pertains and receives a reply to the prompt which includes a recommended solution to the complication. Solutions module 120 may include instructions executed by a processor on a computing system such as a server. Solutions module 120 may interact with storage 140 to store the identified solution or metadata associated with the corresponding issue and solution. Solutions module 120 may execute on a server or computing system accessible by interface 105, behavioral model generator 110, interrogation module 115, storage 140, or a combination thereof. Solutions module 120 may execute on the same server or a different server than the server(s) executing behavioral model generator 110, interrogation module 115, and interface 105.

Foundation model 150 is representative of one or more computing services capable of hosting a foundation model and communicating with solutions module 120. Foundation model 150 may be implemented in the context of one or more server computers co-located or distributed across one or more data centers. Foundation model 150 is representative of a deep learning AI model, such as BERT, ERNIE, T5, XLNet, or of a generative pretrained transformer (GPT) computing architecture, such as GPT-3®, GPT-3.5, ChatGPT®, or GPT-4. Foundation model 150 communicates with solutions module 120, including receiving natural language prompts and returning output, including computer code and natural language text, according to the prompt based on its training. Solutions module 120 communicates with foundation model 150 via one or more internets and intranets, the Internet, wired or wireless networks, local area networks (LANs), wide area networks (WANs), and any other type of network or combination thereof.

Storage 140 interacts with all the online services of operating environment 100 and includes a database of memory housing user codebase uploaded from interface 105, behavioral models obtained from external sources, run-time complications identified by interrogation module 115 from behavioral models, test cases for codebase testing, metadata associated with identified issues and solutions, user account data, and the like. In some implementations, users repeatedly interact with operating environment 100 via user interface 131 to identify and resolve run-time complications within their codebases. For example, a user, such as development operations engineer, may be developing an application that requires numerous libraries to run. Throughout the development of this example application, the development operations engineer may use a debugger to identify run-time complications while the application is developed. Multiple executions of the run-time complication identifier generate data, and storage 140 can store previous user account data wherein the run-time complication identifier optimizes its performance based on past interactions with the user. In some embodiments, data regarding each run of the behavioral model generator 110, interrogation module 115, solutions module 120, or any combination of them may be stored in storage 140 temporarily or permanently.

Codebase 111 represents a source code codebase for a software application. Software applications represented by codebase 111 can include locally installed applications on a personal computer, locally installed applications on a server, applications served from a cloud, web applications, apps for installation on a mobile device, or the like. Codebase 111 may be written in any coding language, such as, for example JAVA, RUBY, C, C++, FORTRAN, PYTHON, JAVASCRIPT, or the like. In some implementations, codebase 111 may be accessed by interface 105 or other elements of operational environment 100 from storage 140 but may also be accessed from user equipment 130.

Behavioral model 113 is representative of a behavioral model generated based on a run-time analysis of a codebase, such as codebase 111. Behavioral model 113 includes operational details and events observed while executing codebase 111 during the run-time analysis. Behavioral model 113 may include elements that were generated based on recordings, trace files, error logs, diagnostic logs, and the like. Behavioral model 113 can also include data by which visual depictions or representations of the codebase, such as sequence diagrams of processes performed by the codebase, can be generated and displayed in user interface 131.

User equipment 130 includes user interface 131. A user may utilize user interface 131 to perform a run-time complication identification and solution generation of an uploaded or stored codebase. User interface 131 may be included in a software application installed on user equipment 130 or accessible via a web browser. User equipment 130 communicates with interface 105 to share data between the user and the online services of the system of operational environment 100.

In a brief exemplary operational scenario, a user wishes to resolve run-time complications of a codebase identified from a behavioral model of the codebase generated by behavioral model generator 110. The user accesses user equipment 130 and interacts with user interface 131 including submitting natural language input from the user to interface 105. Via user interface 131, the user may upload a codebase or access a previously stored codebase for analysis; for the sake of illustration, it will be assumed that the user wishes to access codebase 111 stored by storage 140. User interface 131 communicates with interface 105 to request analysis of codebase 111 based on the user input received via user interface 131. Interface 105 tasks behavioral model generator 110 with generating a behavioral model of codebase 111. Alternatively, if a behavioral model for codebase 111 already exists (e.g., behavioral model 113 from a prior run of the behavioral model generator 110 for that codebase), the previously stored behavioral model may be accessed from storage 140. For the sake of illustration, it will be assumed that the run-time analysis and AI-based resolution will be performed with respect to behavioral model 113. Interface 105 may make behavioral model 113 for codebase 111 accessible to the user via user interface 131.

Continuing the exemplary scenario, interface 105 or behavioral model generator 110 requests interrogation module 115 interrogate behavioral model 113 to identify run-time complications of codebase 111. Interrogation module 115 interrogates the behavioral model 113, and the run-time complications identified during the interrogation are displayed in user interface 131 where the user can select a run-time complication for more information or resolution. The run-time complications may also be persisted by interrogation module 115 or interface 105 to storage 140.

When the user selects a run-time complication presented in user interface 131, an icon is displayed in association with the complication by which the user can indicate a desire for an AI-generated solution to the complication. Upon receiving such an indication, solutions module 120 generates a prompt for submission to foundation model 150 which tasks foundation model 150 with generating a recommended solution for the selected complication. Solutions module 120 populates the prompt with one or more portions of codebase 111 which are relevant to the complication. The prompt may also include other information, such as a description or characterization of the type of complication from behavioral model 113 (e.g., performance issue, security risk, etc.). Solutions module 120 receives a response from foundation model 150 including the recommended solution and, in some implementations, a natural language discussion of the solution. Interface 105 may display the run-time complication and recommended solution in user interface 131 where the user can accept, modify, or reject the recommended solution. Solutions module 120 or interface 105 may also store AI-generated solutions or records of revisions to codebase 111 based on AI-generated solutions in storage 140.

To generate the prompt to the foundation model to fix a run-time complication, the system populates the prompt with relevant sections of the code and metadata associated with the complication. In an implementation, to identify sections of code to include in the prompt for a given complication, the complication is pinpointed in behavioral model 113. The portions of source code in codebase 111 corresponding to the complication are identified according to location in behavioral model 113; for example, the behavioral model may include tags or other identification points that correspond to tags inserted in codebase 111. Metadata included in the prompt may be derived from metadata of behavioral model 113, such as details of the identified issues associated with the lines or sections of the offending source code, the date the issue was introduced, a category of the issue (e.g., performance, security, failed test case, and the like), a version in which the issue was introduced, a link to connect the issue to an issue tracking system, an issue number, a link to corresponding location in the associated behavioral model, etc.), and so on.

Upon submitting the prompt to foundation model 150, solutions module 120 receives a reply to the prompt including a recommended solution to the selected complication. Interface 105 causes the recommended solution in user interface 131, including a block or snippet of code which may be patched into codebase 111. In some scenarios, foundation model 150 is prompted to also provide a natural language analysis of the selected run-time complication and/or explanation of the solution for display in user interface 131. When interface 105 receives an indication that the user accepts the recommended solution (e.g., by means of a graphical input device in user interface 131), interface 105 effects a repair of codebase 111 by replacing the corresponding portion of the codebase with the code snippet generated by foundation model 150 For example, if the recommended solution includes a new version of an existing function definition, the existing function definition may be overwritten with the new version. In some scenarios, the repair may be implemented by installing new and/or modified code generated by foundation model 150 into the codebase in accordance with instructions provided in the solution. In some implementations, the replacement code is displayed in a code editor where the user can modify the code before accepting the code for installation in the codebase.

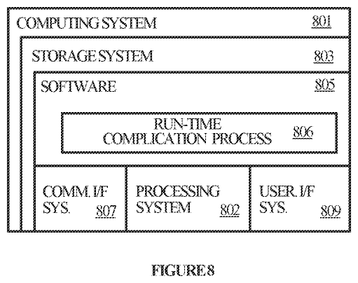

FIG. 2 illustrates computing device 200 for identifying and resolving run-time complications in a codebase in a local implementation for downloadable implementations. Computing device 200, of which computing system 801 of FIG. 8 is representative, includes a processing unit such as processor 205 responsible for reading non-transitory computer-readable storage media such as memory 210. (Computing system 801 of FIG. 8 depicts additional functionality of a standard computing device excluded from device 200 for case of description.) Computing device 200 may be any computing device that can download and execute software for identifying and resolving run-time complications. For example, computing device 200 may be a server, personal computer, laptop, server farm, distributed computing environment, or the like.

Memory 210 includes codebase 211, execution data, 212, behavioral models 213, problem patterns 215, metadata 217, and application 220. Codebase 211 may be the same as codebase 111 of FIG. 1. Codebase 211 may be user uploaded, stored on computing device 200 for testing, or otherwise supplied to device 200. Codebase 211 may be collected using a user interface of application 220. Application 220 performs the functions to identify run-time complications within codebase 211 and provide recommended solutions for at least one of the identified run-time complications.

Execution data 212 represents operational definitions that specify the behavior of elements of a specific coding language (e.g., JAVA, RUBY, etc.). For example, execution data 212 may include test cases for executing codebase 211, information for generating synthetic traffic, data for defining code blocks for specific code block execution, data for defining specific processes for execution, and the like.

Behavioral models 213 represents a run-time analysis of codebase 211 and includes operational details and events observed while executing codebase 211. Behavioral models 213 may include elements that were generated based on recordings, trace files, error logs, diagnostic logs, and the like. Behavioral models 213 are generated by behavioral model generator 223.

Problem patterns 215 represent problem patterns, e.g., a collection or repository of problem patterns, which are used to identify run-time complications. Newly classified problem patterns may be added to problem patterns 215 by the run-time identification system as run-time complications are identified. Other sources or collections of known problem patterns include the MITRE common weaknesses enumeration (CWE) reports as well as other reports developed by site reliability engineers, development operation engineers, or qualified individuals of the like. MITRE CWE reports are a predefined list of common software weaknesses and flaws developed by an outside corporation which primarily detail static software problems and security issues.

Metadata 217 may represent metadata collected or generated in identifying issues, solutions, or both. For example, the metadata may include recency information about identified run-time complications such as a version the issue was introduced in or a date the issue was introduced. Metadata 217 may also include a category of the issue (e.g., performance issue, security issue, failed test case, or the like), connection information to connect to an issue tracking system, an issue number, a type of flag to use for visualizing the issue (e.g., a squiggle underline, a straight underline, highlighting, a pin, or the like), solution information for identified complications, or any other relevant data associated with the specific portion of the codebase or the specific portion of the behavioral model associated with the identified issue.

Application 220 may provide a user interface based on user interface module 221. The user may, for example, provide access to codebase 211 for analysis and run-time complication identification and solution generation. Application 220 includes user interface module 221, behavioral model generator 223, interrogation module 225, and solutions module 227. In an implementation, a user interacts with computing device 200 through user interface module 221. The user may provide access to codebase 211 using the user interface. Codebase 211 may be stored in memory 210 if not previously stored. Accordingly, processor 205 may execute codebase 211 when in memory 210. Processor 205 may further execute application 220 to generate and interrogate a behavioral model of codebase 211 and provide recommended solutions which mitigate at least one identified run-time complication as described in more detail below.

Foundation model 250, of which foundation model 150 of FIG. 1 is representative, communicates with computing device 200 to receive prompts and return output generated in response to the prompts. Foundation model 250 may communicate with device 200 via an API hosted by foundation model 250. Foundation model 250 receives run-time complications from computing device 200 and returns output including a recommended solution for the complication.

In an implementation, application 220 generates behavioral model 213 of codebase 211 using behavioral model generator 223. The generated behavioral model depicts a run-time behavior of codebase 211. Application 220 interrogates behavioral model 213 to identify run-time complications within codebase 211 using interrogation module 225. In some embodiments, interrogation module 225 obtains behavioral model 213 and compares this model to problem patterns 215. Problem patterns 215 may include a predefined set of common error patterns found within codebases. Such patterns may include a variety of types which define both static and dynamic problem patterns. By comparing problem patterns 215 to behavioral model 213, interrogation module 225 is able to identify problem patterns within the behavioral model 213. The identification of these problem patterns within the behavioral model 213 may result in the identification of run-time complications within codebase 211. In some embodiments, AI processing may be used to interrogate behavioral model 213 and/or codebase 211 to identify problem patterns, anomalies, discrepancies, and other errors and design flaws.

Upon predicting the run-time complications or potential run-time complications within codebase 211, application 220 may generate recommended solutions for the complications using solutions module 227. The recommended solutions may mitigate or resolve the run-time complications by providing the recommended solution that the user can implement in codebase 211. To generate a solution for an identified run-time complication, application 220 or solutions module 227 prompts foundation model 250 to generate computer code in the appropriate programming language which will address the issue identified in the complication. The prompt includes at least one portion of codebase 211 and information relating to the complication from behavioral model 213.

Foundation model 250 generates and returns a recommended solution to resolve or mitigate the complication. The recommended solution generated by foundation model 250 may include a code snippet to replace a portion of the source code in codebase 211 and information about the run-time complication that can be used to address the design flaw causing the run-time complication. The code snippet and/or other information may be displayed to the user using a popup window, such as a code editor window, where the user can accept, modify, or reject the code snippet.

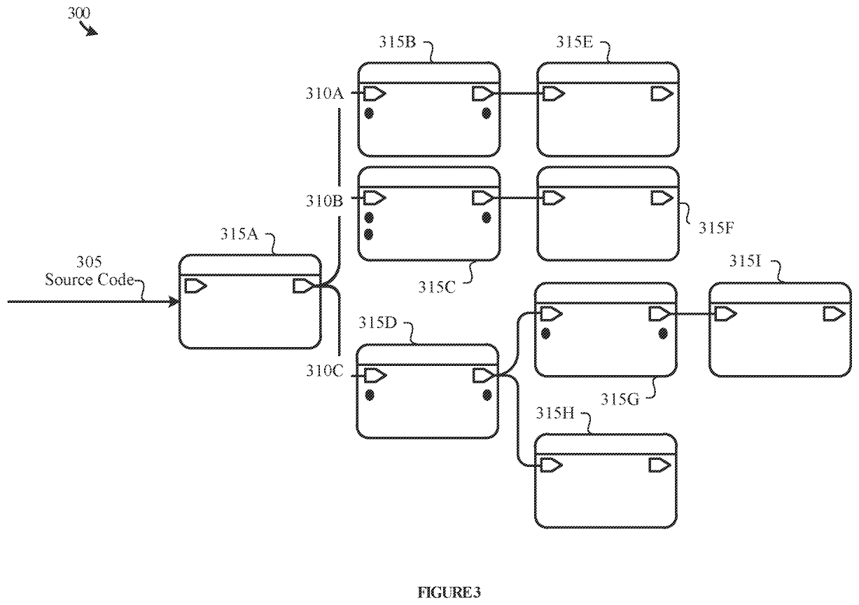

FIG. 3 illustrates visual depiction 300 which is representative of a visual depiction of a behavioral model or portion thereof in an implementation. Visual depiction 300 is a visual representation of the behavioral model of the source code of codebase 305. Codebase 305 is representative of codebase 111 of FIG. 1 or other codebases used to generate behavioral models. The behavioral model is generated based on a run-time operation and analysis of a codebase 305. Codebase 305 may be source code in any coding language. Examples of codebase 305 include but are not limited to web applications, locally installed applications, and applications served from a cloud. Visual depiction 300 depicts an example of a behavioral model that may be created by a generation module, such behavioral model generators 110 or 223 of FIGS. 1 and 2, respectively.

In some implementations, codebase 305 is submitted to a generation module that generates the corresponding behavioral model that represents the run-time operation of the codebase 305. The generation module may exhaustively probe the codebase 305 to identify parameters, connection points, and the like to ensure a thorough representation of the codebase 305 in operation. The behavioral model generated by the generation module may including information by which other diagrams, such as sequence diagrams, can be rendered. The behavioral model may also include information by which a prompt to a foundation model concerning a portion of the codebase can be populated, such as relationships between blocks of code in codebase 305.

The behavioral model of codebase 305 may be stored as a visual depiction such as visual depiction 300, or may instead be stored as data representing the behavior of the codebase 305 including connection information, operational paths (e.g., codepaths), functional categories, and the like. As shown in visual depiction 300, operational paths 310A, 310B, and 310C represent the path of the codebase in operation. More specifically, operational paths 310A, 310B, and 310C detail the execution of codebase 305 functions in real-time. The code blocks 315A, 315B, 315C, 315D, 315E, 315F, 315G, 315H, 315I represent data transformations or other operations that include one or more inputs from operational paths 310 and one or more outputs to other operational paths 310.

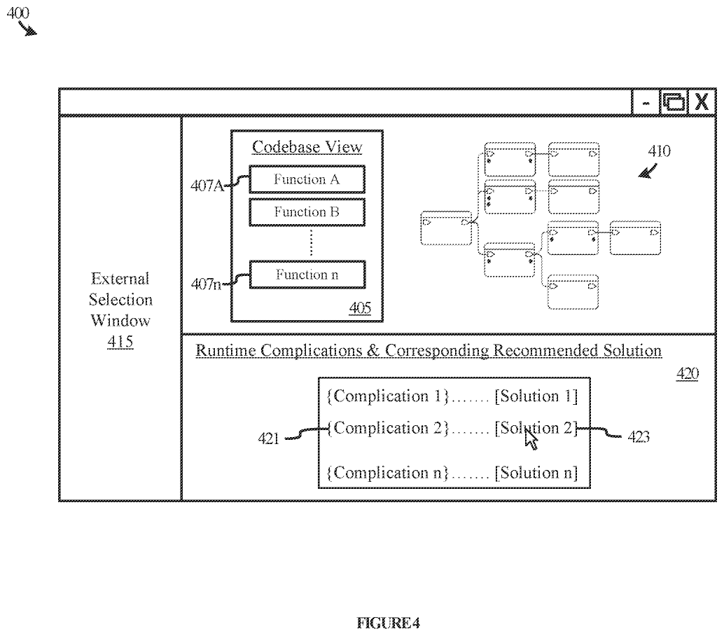

FIG. 4 depicts user interface 400, of which user interface 131 of FIG. 1 is representative, of an application hosted by a system for identifying and resolving run-time complications in an implementation. User interface 400 allows visual access by a user to the functionality (either locally or on a cloud-based system) to intelligentially identify run-time complications and generate recommended solutions. User interface 400 includes codebase view 405, visual depiction 410 of a behavioral model, external selection window 415, and pane 420 for displaying run-time complications & corresponding solutions. User interface 400 is representative of a graphical user interface accessed via a computing device such as computing device 200 of FIG. 2, examples of which include computers, tablets, phones, laptops, and the like.

In an implementation, codebase view 405 displays subroutines of a user codebase spanning Function A 407A through Function n 407n. These functions represent the individual subroutines that make up a codebase, such as codebase 111 of FIG. 1 or codebase 211 of FIG. 2. For example, Function A 407A could represent a main function module which executes different subroutines contained within the subsequent functions (i.e., Function B through Function n). While the subsequent functions, such as Function n 407n, execute subroutines of the user codebase. The language used to generate codebase in codebase view 405 may be any type of coding language and may use any programming paradigm including structured, procedural, functional, modular, or object-oriented. Accordingly, codebase view 405 may include objects, structures, procedures, modules, or the like.

Visual depiction 410 displays to a user the visual representation of their codebase in operation by providing a visual depiction of the behavioral model. Visual depiction 410 can be generated locally, as displayed in FIG. 2, or within a cloud-based system as depicted in FIG. 1. After the generation of visual depiction 410, user interface 400 displays the run-time depiction of the codebase to the user.

In an implementation, external selection window 415 displays various options within user interface 400. User interface 400 provides access to an application, so external selection window 415 may display various abilities available in the application. Examples may include options to select other user codebases, options to generate and interrogate a behavioral model, and the like.

Pane 420 displays a list of run-time complications within the codebase (e.g., as may be generated by interrogation module 115 of Figure a), including run-time complication 421, as well as a list of at least one corresponding solution (e.g., as may be generated by solutions module 120 of FIG. 1 via integration with foundation model 150), including recommended solution 423 generated by a foundation model, to either resolve or mitigate these complications. Run-time complications may include memory leaks, security issues, performance issues, inefficient data access, improper access control, and the like. Within pane 420, the user is able to select different solutions such as recommended solution 423, as illustrated.

Upon the user selection of a recommended solution, user interface 400 may display a pop-up window including the codebase complication, recommended solution 423, and an input device by which the user can accept the recommended solution. For example, the recommended solution may include a code snippet (e.g., function, object, etc.) to mitigate or resolve the identified issue of the original code segment within the codebase. When the user accepts recommended solution 423, the application installs or implements the code snippet in the codebase.

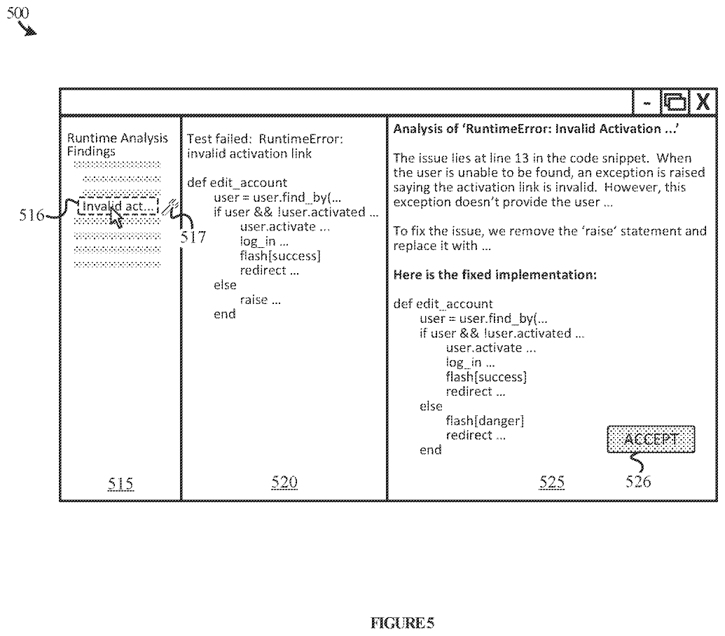

FIG. 5 illustrates user interface 500 of an application of a system for generating solutions to mitigate or resolve run-time complications identified in a codebase via a foundation model integration in an implementation. The application hosts user interface 500, of which user interface 131 of FIG. 1 is representative, which includes selection pane 515, findings pane 520, and solutions pane 525. Selection pane 515 displays findings or run-time complications identified by a run-time complication identifier, such as interrogation module 115 of FIG. 1 or an element of computing device 200 of FIG. 2. Findings pane 520 displays information about a run-time finding or complication selected by a user in selection pane 515, such as the complication type and a portion of the codebase to which the complication relates. Solutions pane 525 displays a solution generated by a foundation model for the selected run-time complication along with information about the solution.

In an exemplary operational scenario, a user performs a user input in relation to complication 516 in selection pane 515, such as selecting run-time complication 516. When the user selects run-time complication 516 in selection pane 515, a synopsis of the complication is displayed in findings pane 520, including a label or classification of the complication (e.g., “Runtime Error”), a brief description (e.g., “invalid activation link”), and a portion of the codebase to which run-time complication 516 pertains.

In some implementations, when the user selects or mouses over a selection, an icon (e.g., icon 517) is displayed by which the user can initiate solution generation via the foundation model integration for the selected run-time complication. When the user selects icon 517, the application hosting user interface 500 generates a prompt for a foundation model (e.g., foundation model 150 of FIG. 1) which includes a portion of the codebase to which run-time complication 516 pertains, such as the portion displayed in findings pane 520 but possibly other portions of the codebase as well. The prompt tasks the foundation model with generating a solution to mitigate or resolve run-time complication 516.

The application receives a reply from the foundation model including a code snippet generated by the model in response to the prompt and a natural language analysis or explanation of the solution with respect to run-time complication 516. In some implementations, the prompt is generated according to a prompt template which includes fields which are populated based on the complication. The prompt may also include rules by which the foundation model is to generate its output, such as the programming language of the codebase and formatting rules by which the system can parse the output to extract the code snippet, the analysis, and so on.

When the reply to the prompt is received from the foundation model, the application displays content from the output in solutions pane 525. For example, as illustrated, solutions pane 525 displays the analysis of run-time complication 516 including an explanation of the solution and a code snippet to be added to or patched into the codebase to resolve the issue. The offending source code lines as identified by the foundation model may be highlighted, tagged, underlined, or otherwise flagged when displayed in solutions pane 525. In some implementations, solutions pane 525 includes button 526 by which the user can cause the application to implement or install the code snippet in the codebase. In some implementations, the user may modify the code snippet prior to acceptance. In some implementations, the code snippet is validated by the application (e.g., by a solutions module) prior to displaying the code snippet for acceptance or prior to implementing the code snippet in the codebase. In some cases, the system performs a new run-time analysis on the updated codebase to generate an updated behavioral model. The updated behavioral model can be used to identify an updated set of run-time complications for the codebase. Resolutions of run-time complications may also be stored for reference, auditing purposes, etc.

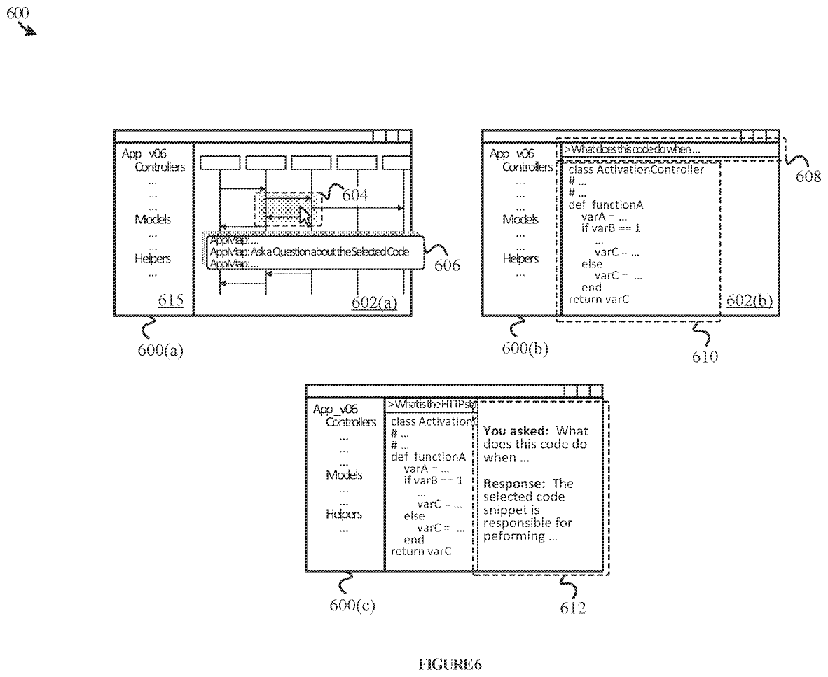

FIG. 6 illustrates user interface 600 of an application of a system for submitting user inquiries with respect to code in a codebase via a foundation model integration in an implementation. The application hosts user interface 600 (shown in various stages of operation as user interfaces 600(a), 600(b), and 600(c)) which includes selection pane 615 and pane 602 (shown in various stages of operation as panes 602(a) and 602(b)). Selection pane 615 displays a menu (e.g., dropdown menu) or hierarchical listing of code sections of the codebase from which the user can select a section of code for further examination. Pane 602 may include tabbed views of portions of the codebase, such as a tab for displaying sequence diagrams of a selected code section and a tab for displaying lines of code of the selected code section.

In an exemplary operational scenario, when a user selects a code section in pane 615 of user experience 600(a), the application hosting user interface 600 causes a sequence diagram of the selected code to be displayed in pane 602(a). Portions of the sequence diagram corresponding to portions of the codebase are selectable. As illustrated in user experience 600(a), a user selects portion 604 in pane 602(a) which causes menu 606 of actions or tools to be displayed, including the option to ask a question about the selected code.

Continuing to user experience 600(b), the application identifies block 610 of code as pertaining to user-selected portion 604 based on relational information in a behavioral model of the codebase and displays block 610 in pane 602(b). Having selected the option to “Ask A Question . . . ” about portion 604, the user enters user input 608 in user interface 600(b) including a query about portion 604 (“What does this code do when . . . ”). When the user submits user input 608, the application generates a prompt which tasks a foundation model with generating a response to query posed in user input 608. The application automatically populates the prompt with the relevant portions of the codebase, i.e., portion 604, but possibly also other relevant portions, such as portions on which portion 604 depends, portions which depend from portion 604, or portions identified according to operational paths or threads of execution to which portion 604 is associated. In some scenarios, the user may select a portion of interest (such as one or more lines from block 610) for an inquiry, and the application populates the prompt to include the portions of code relating to the selection based on the relational information in the behavioral model.

When the prompt is submitted to the foundation model, the application receives a reply generated in response to the prompt, including content generated in response to the user inquiry. In user experience 600(c), the application displays pane 612 including the user input and content received from the foundation model.

FIG. 7 illustrates process 700 for identifying and resolving run-time complications via a foundation model integration for solution generation in an implementations. Process 700 may be implemented on software, hardware, or any combination thereof. For example, process 700 can be executed by a server implementing interface 105 of FIG. 1 or by computing device 200 of FIG. 2.

A system accesses a behavioral model of a codebase (step 701). For example, computing device 200 may access behavioral model 213 from memory 210, or the server implementing interface 105 or solutions module 120 may access behavioral model 113 from storage 140. The behavioral model may be generated by a behavior model generator, such as behavioral model generator 110 or 223. The behavioral model includes a run-time representation of the codebase generated based on a thorough or exhaustive probing of the codebase using extensive test scripts, artificial intelligence networks, or any other method of probing a codebase during run-time to generate an exhaustive analysis of run-time behavior of the codebase.

The system interrogates the behavioral model to predict run-time complications within the codebase (step 703). Behavioral model interrogation may be performed by an interrogation module, such as interrogation modules 115 or 225. In an implementation, the system interrogates the behavioral model to identify complications by comparing the behavioral model to a predefined set of problem patterns. These problem patterns identify both static and dynamic complications related to security, production, and the like. If a problem pattern is identified within the behavioral model, a run-time complication is identified within the codebase. In some embodiments, AI models are used to interrogate the behavioral model to identify run-time complications. When complications are found, they may be stored in association with the codebase, for example, in storage 140 or memory 210.

The system receives user input including a selection of a run-time complication (step 705). In an implementation, a user interface (e.g., user interface 131) receives user input which indicates a selection of a run-time complication identified in the behavioral model of the codebase (e.g., as illustrated in selection pane 515 of FIG. 5). For example, the user interface may display a selectable list of run-time complications identified for the codebase from which the user can select a run-time complication for further examination or resolution.

The system generates a prompt to elicit a solution for the run-time complication from a foundation model (step 707). In an implementation, the system selects a prompt template for tasking a foundation model with generating a solution to a run-time complication identified in a behavioral model of a codebase. The system populates the prompt with information about the complication (e.g., the type of complication, a description of the complication) and one or more portions of the codebase which pertain to the run-time complication. The system may interrogate the behavioral model to identify which portions of the codebase pertain to a given complication. The prompt may task the foundation model with generating code to resolve the complication, such as a code snippet to replace existing code in the codebase. The prompt may further task the foundation model with generating an analysis of the complication and/or explanation of the proposed solution. In some implementations, the prompt may instruct the foundation model with returning its output in a particular format, such as a Jupyter Notebook format.

The system causes display of the solution generated by the foundation model in the user interface (step 709). In an implementation, the system displays the solution along with an explanation of the solution in the user interface where the user can accept the solution for implementation in the codebase or reject the solution. For example, as shown in FIG. 5, user interface 500 includes selection pane 515 where the user can select a run-time complication. The system displays the solution generated by the foundation model in solutions pane 525, including a code snippet to replace a corresponding code snippet in the codebase and an explanation of how the recommended fix resolves or mitigates the issue. In some implementations, the user may modify the generated code, e.g., by double-clicking the snippet to bring up a window for editing the code, then click “Accept” (e.g., button 526) to patch the code into the codebase.

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof. Computing device 801 may be device 200, user equipment 130, computing devices that implement cloud services including behavioral model generator 110, interrogation module 115, solutions module 120, interface 105, or storage 140, a computing device that implements user interface 400, or a computing device that implements process 700.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled with storage system 803, communication interface system 807, and user interface system 809.

Processing system 802 loads and executes software 805 from storage system 803. Software 805 includes and implements run-time complication process 806, which includes the behavioral model generation of a codebase, behavioral model interrogation to identify the run-time complications, and the solution generation via a foundation model integration. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise any type of processor (e.g., a micro-processor) and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. In other words, the computer readable storage media is a non-transitory computer readable media.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or other systems.

Software 805 (including run-time complication process 806) may be implemented in program instructions and among other functions may, when executed by processing system 802, direct processing system 802 to operate as described with respect to the various operational scenarios, sequences, and processes illustrated herein. For example, software 805 may include program instructions for implementing a multipoint format process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support the described run-time complication processes with respect to a codebase, including identifying run-time complications and obtaining AI-generated solutions. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of such productivity applications, they apply as well to other contexts such as gaming applications, virtual and augmented reality applications, business applications, and other types of software applications. Likewise, the concepts apply not just to electronic documents, but to other types of content such as in-game electronic content, virtual and augmented content, databases, and audio and video content.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method, comprising:
accessing a behavioral model of a codebase, wherein the behavioral model represents a run-time behavior of the codebase generated based on a run-time analysis of the codebase;
interrogating the behavioral model to predict run-time complications within the codebase;
receiving, in a user interface, user input comprising a selection of a run-time complication of the run-time complications;
generating a prompt to elicit a reply from a foundation model, wherein the prompt tasks the foundation model with generating a solution for the selected run-time complication and wherein the prompt includes a portion of the codebase corresponding to the selected run-time complication; and
causing display of the solution for the selected run-time complication in the user interface.

2. The method of claim 1, wherein generating the prompt further comprises identifying the portion of the codebase corresponding to the selected run-time complication based on the behavioral model.

3. The method of claim 1, wherein the prompt includes information from the behavioral model about the selected run-time complication, wherein the information includes a type of the selected run-time complication.

4. The method of claim 1, wherein the prompt further tasks the foundation model with generating an explanation of the selected run-time complication and the solution, and wherein the method further comprises causing display of the explanation in the user interface in association with the solution.

5. The method of claim 1, wherein the solution comprises a code snippet generated by the foundation model in response to the prompt.

6. The method of claim 5, wherein the method further comprises patching the codebase with the code snippet.

7. The method of claim 1, wherein the user input comprises a selection of a portion of a visual representation of the codebase, wherein the visual representation is generated based on the behavioral model.

8. The method of claim 7, wherein the visual representation comprises a sequence diagram of the codebase generated based on information from the behavioral model.

9. A system comprising:
one or more processors; and
a memory operatively coupled with the one or more processors, the memory having stored thereon instructions that, upon execution by the one or more processors, cause the one or more processors to:
access a behavioral model of a codebase, wherein the behavioral model represents a run-time behavior of the codebase generated based on a run-time analysis of the codebase;
interrogate the behavioral model to predict run-time complications within the codebase;
receive, in a user interface, user input comprising a selection of a run-time complication of the run-time complications;
generate a prompt to elicit a reply from a foundation model, wherein the prompt tasks the foundation model with generating a solution for the selected run-time complication and wherein the prompt includes a portion of the codebase corresponding to the selected run-time complication; and
cause display of the solution for the selected run-time complication in the user interface.

10. The system of claim 9, wherein to generate the prompt, the instructions further cause the one or more processors to identify the portion of the codebase corresponding to the selected run-time complication based on the behavioral model.

11. The system of claim 9, wherein the prompt includes information from the behavioral model about the selected run-time complication, wherein the information includes a type of the selected run-time complication.

12. The system of claim 9, wherein the prompt further tasks the foundation model with generating an explanation of the selected run-time complication and the solution, and wherein the instructions further cause the one or more processes to cause display of the explanation in the user interface in association with the solution.

13. The system of claim 9, wherein the solution comprises a code snippet generated by the foundation model in response to the prompt.

14. The system of claim 13, wherein the instructions further cause the one or more processors to patch the codebase with the code snippet.

15. The system of claim 9, wherein the user input comprises a selection of a portion of a visual representation of the codebase, wherein the visual representation is generated based on the behavioral model.

16. The system of claim 15, wherein the visual representation comprises a sequence diagram of the codebase generated based on information from the behavioral model.

17. A computer-readable media device having stored thereon instructions that, upon execution by one or more processors, cause the one or more processors to:
access a behavioral model of a codebase, wherein the behavioral model represents a run-time behavior of the codebase generated based on a run-time analysis of the codebase;
interrogate the behavioral model to predict run-time complications within the codebase;
receive, in a user interface, user input comprising a selection of a run-time complication of the run-time complications;
generate a prompt to elicit a reply from a foundation model, wherein the prompt tasks the foundation model with generating a solution for the selected run-time complication and wherein the prompt includes a portion of the codebase corresponding to the selected run-time complication; and
cause display of the solution for the selected run-time complication in the user interface.

18. The computer-readable media device of claim 17, to generate the prompt, the instructions further cause the one or more processors to identify the portion of the codebase corresponding to the selected run-time complication based on the behavioral model.

19. The computer-readable media device of claim 17, wherein the prompt includes information from the behavioral model about the selected run-time complication, wherein the information includes a type of the selected run-time complication.

20. The computer-readable media device of claim 17, wherein the solution comprises a code snippet generated by the foundation model in response to the prompt.
